(19) United States
(12) Patent Application Publication
(10) Pub. No.: US 2013/0093604 A1
(43) Pub. Date: Apr. 18, 2013

(54) LOGISTICAL MANAGEMENT OF FIELD WORK

(71) Applicants: Matthew M. Highstrom, South Lyon, MI (US); Timothy J. Grost, Clarkston, MI (US); Andrew W. Gellatly, Macomb, MI (US)

(72) Inventors: Matthew M. Highstrom, South Lyon, MI (US); Timothy J. Grost, Clarkston, MI (US); Andrew W. Gellatly, Macomb, MI (US)

(73) Assignee: GM GLOBAL TECHNOLOGY OPERATIONS LLC, Detroit, MI (US)

(21) Appl. No.: 13/272,549

(22) Filed: Oct. 13, 2011

(51) Int. Cl. G08G 1/123

(52) U.S. Cl. 340/990

(57) ABSTRACT

Implementing a resource tracking service includes searching a database in response to a request for a resource from a first vehicle, retrieving a record from the database that is identified with the resource, the record mapped to a second vehicle. Implementing a resource tracking service also includes determining a geographic location of the second vehicle, and populating a navigation system map at the first vehicle with an icon reflecting the geographic location of the second vehicle.

### FIELD OF THE INVENTION

The subject invention relates to logistics and, more particularly, to the logistical management of field work.

### BACKGROUND

Currently, work crew logistics management is performed through telephone calls in which information and commands are disseminated between a central office and relevant work crew members. For example, if one project team requires assistance in terms of additional manpower or equipment, the project manager calls a head office or facility requesting these resources and the head office is responsible for tracking down and assigning additional crew and/or equipment, or redistributing crew members and/or equipment from other work locations. This process can take considerable time depending on the availability and/or current location of these additional resources, thereby potentially impeding the progress of the project underway.

Accordingly, it is desirable to provide a way to streamline the logistical management of field operations and work crew allocation.

### SUMMARY OF THE INVENTION

In one exemplary embodiment of the invention, a system for implementing resource tracking services is provided. The system includes a computer processor disposed in a vehicle and logic executable by the computer processor. The logic is configured to implement a method. The method includes searching a database in response to a request for a resource, the request received from a first vehicle. The method also includes retrieving a record from the database that is identified with the resource, the record mapped to a second vehicle. The method further includes determining a geographic location of the second vehicle, and populating a navigation system map at the first vehicle with an icon reflecting the geographic location of the second vehicle.

In another exemplary embodiment of the invention, a method for implementing resource tracking services is provided. The method includes searching a database in response to a request for a resource, the request received from a first vehicle. The method also includes retrieving a record from the database that is identified with the resource, the record mapped to a second vehicle. The method further includes determining a geographic location of the second vehicle, and populating a navigation system map at the first vehicle with an icon reflecting the geographic location of the second vehicle.

In yet another exemplary embodiment of the invention a computer program product for implementing resource tracking services is provided. The computer program product includes a storage medium embodied with machine-readable program instructions, which when executed by a computer, cause the computer to implement a method. The method includes searching a database in response to a request for a resource, the request received from a first vehicle. The method also includes retrieving a record from the database that is identified with the resource, the record mapped to a second vehicle. The method further includes determining a geographic location of the second vehicle, and populating a navigation system map at the first vehicle with an icon reflecting the geographic location of the second vehicle.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a block diagram of a system upon which resource tracking services may be implemented in accordance with an embodiment;

FIG. 2 is a flow diagram describing a process for implementing resource tracking in accordance with an embodiment;

FIG. 3 is a database table with sample data in accordance with an embodiment; and

FIG. 4 is a user interface screen with sample resource tracking data in accordance with an embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

In accordance with an exemplary embodiment of the invention, resource tracking services are provided. The resource tracking services provide a means for tracking the movement and location of work vehicles, as well as equipment carried by or loaded on the vehicles, and enabling the direct communication of this information among work crews in the field via communication components in the vehicles. The resource tracking eliminates the need for logistical control and management of vehicles from a central or head office, thereby allowing the work crew members or managers to redistribute resources or crew members faster and more efficiently than existing methods.

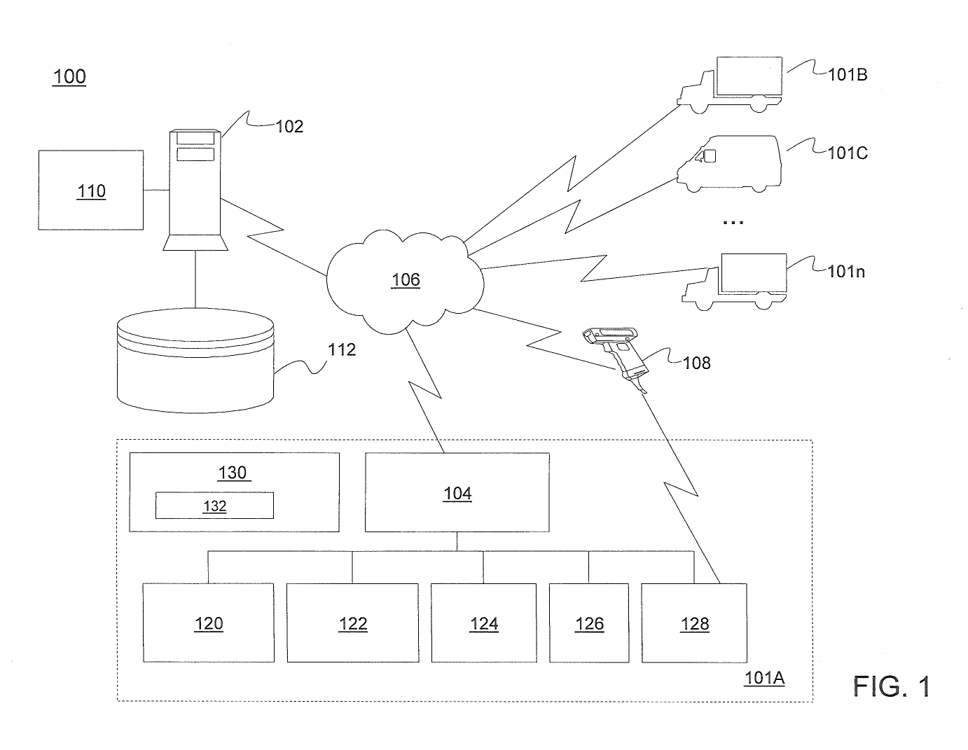

Turning now to FIG. 1, a system 100 upon which resource tracking services may be implemented will now be described in an exemplary embodiment. The system 100 includes vehicles 101A-101n which, in turn, include components used in performing the resource tracking services. The vehicles 101A-101n may be any type of commercial vehicles known in the art. As shown in FIG. 1, the system 100 also includes a host system 102. Each of the vehicles 101A-101n and the host system 102 are communicatively coupled to one another via one or more networks 106. Also included in the system 100 is a scanning device (also referred to as “scanner”) 108. The scanner 108 may include communication components for communicating scanned data over one or more of networks 106. Alternatively, or in addition thereto, the scanner 108 may communicate scanned data directly to a storage device over a low frequency network, as will be described herein. In one embodiment, the scanner 108 is a radio frequency identification (RFID) scanning device.

The host system 102 may be implemented as a high-speed computer processing device (e.g., a mainframe computer) capable of handling a high volume of activities conducted by the vehicles 101A-101n in regard to the host system 102. The host system 102 may be operated by an enterprise or organization implementing the exemplary resource tracking services described herein. In one embodiment, the host system 102 may be operated by a telematics service provider, such as OnStar®, and the vehicles 101A-101n may be equipped with the corresponding telematics hardware components. The host system 102 may operate as a web server including a web site for generating accounts for the resource tracking services. The host system 102 may also operate as an application server including one or more applications for providing the resource tracking services described herein. These one or more applications are collectively referred to herein as resource tracking logic 110. In an embodiment, the host system 102 is communicatively coupled to a storage device 112, which stores accounts established for registered users of the resource tracking services, as well as related data used to facilitate the resource tracking services. Account records created via the resource tracking logic may include registered user identification data (e.g., name, address, employer business name and address), and any other characteristics of the users for use in implementing the resource tracking services. These characteristics are described further herein. While the storage device 112 is shown in FIG. 1 as a separate physical device from the host system 102, it will be understood that the storage device 112 may be integrated into the host system 102 as internal storage (e.g., as a hard disk drive).

The networks 106 may be any type of known networks in the art. For example, the networks 106 may be a combination of public (e.g., Internet), private (e.g., local area network, wide area network, virtual private network), and may include wireless and wireline transmission systems (e.g., satellite, cellular network, terrestrial networks, etc.).

The vehicles 101A-101n reflect work or commercial vehicles used in the course of a business enterprise (e.g., construction, public works, utilities, etc.). The vehicles 101A-101n will now be described with respect to a single vehicle 101A for ease of explanation. It will be understood that the components and features described herein with respect to vehicle 101A apply to each of the vehicles 101A-101n. The vehicle 101A includes a communication system 104, which in turn comprises input/output (I/O) components 120, a computer processor 122, logic 124, a global positioning system (GPS) device 126, and a storage device 128, each of which may be in communication with one another via a communications bus (not shown). The communication system 104 may be part of a vehicle control module. The input components of the I/O components 120 may include input controls (e.g., keypad) and/or may be implemented by voice recognition technology and voice commands (e.g., via a microphone). The output components of the I/O components 120 may include a display screen or monitor, and/or may include an audio system (e.g., car speakers) that presents audio messages or information to occupants (e.g., work crews) of the vehicle 101A. The computer processor 122 executes the logic 124, which in turn is configured to receive inputs via the I/O components 120 in assisting a user to access information provided by the resource tracking services, as well as to communicate with other vehicles 101B-101n.

The GPS 126 may be implemented by a navigation system. The GPS 126 provides vehicle location information to the logic 124, which may be used to identify the location of the vehicle 101A on a navigation map of the navigation system. The location information may be transmitted to the host system 102, and the resource tracking logic 110 may be configured to provide this information to other vehicles 101B-101n over networks 106 to identify vehicle 101A's location on their navigation system maps. In an exemplary embodiment, the storage device 128 receives and stores inventory information, along with vehicle information, and sends this information to the host system 102 for access by all vehicles 101A-101n.

The vehicle 101A also includes one or more inventory items, such as inventory item 130. The inventory items may include any type of equipment or devices used by the work crew during the course of business. The inventory item 130 includes a tag 132 that is encoded with information describing the inventory item 130. The tag 132 may be an RFID tag that is affixed to the inventory item 130.

While the exemplary resource tracking services are described herein with respect to a communication system 104, which is described as an onboard vehicle system, it will be understood that other implementations may be configured to realize the advantages of the invention. For example, a portion of the functionality performed by the communication system 104 may be implemented using a wireless communications device, e.g., a smart phone and corresponding logic 124, that is communicatively coupled in a wireless fashion to components of the communication system 104 via a short-range communications network (e.g., via BlueTooth™).

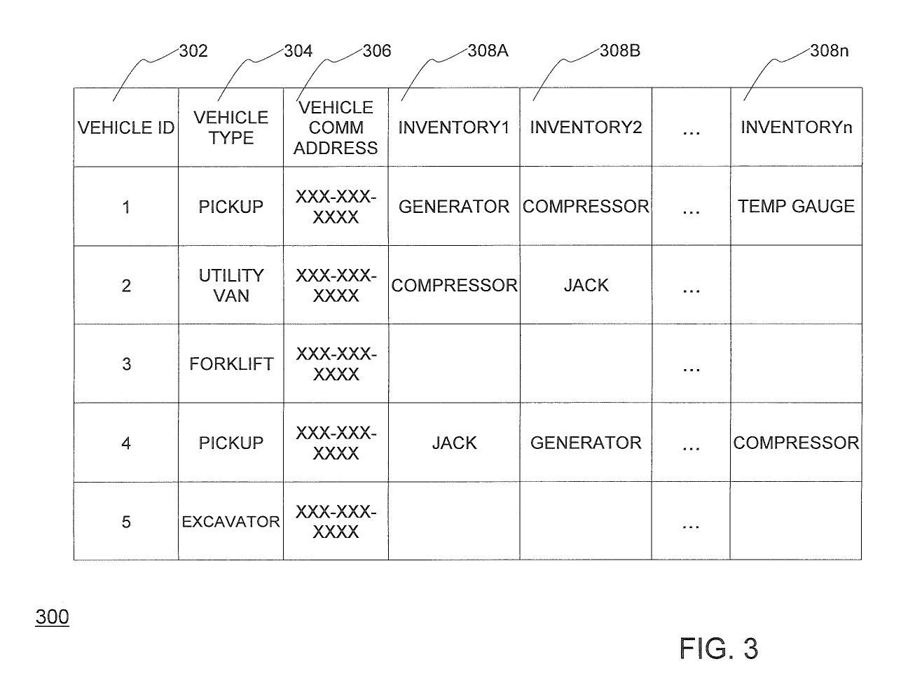

In an exemplary embodiment, the resource tracking logic 110 is configured to receive and process vehicle information for the vehicles 101A-101n in conjunction with inventory information for the vehicles 101A-101n. The resource tracking logic 110 builds a database from this information, which is used to initiate communications among the vehicles 101A-101n, as will be described herein. A sample database table 300 is shown in FIG. 3. In one embodiment, a scanning device (e.g., scanner 108) scans tags 132 on inventory items 130 that are disposed in, or will soon be disposed in, respective vehicles 101A-101n. If a dedicated scanner is assigned to each vehicle, the scanner may be programmed with the vehicle information, such as a vehicle identifier, a vehicle type, and a vehicle communication address (e.g., a phone number or data messaging address depending upon the type of communications system used by the vehicle). Alternatively, the vehicle identifier, vehicle type, and communication address may be input into the scanner at the time of inventory scanning. In a further embodiment, the vehicle identifier, vehicle type, and communication address may be programmed into the vehicle itself, e.g., via the I/O components 120, processor 122, and logic 124 in the vehicle. In yet a further embodiment, the vehicle identifier, vehicle type, and communication address may be programmed into a smart phone or wireless communication device associated with a crew member assigned to a vehicle, and the logic 124 is configured to communicate with the smart phone.

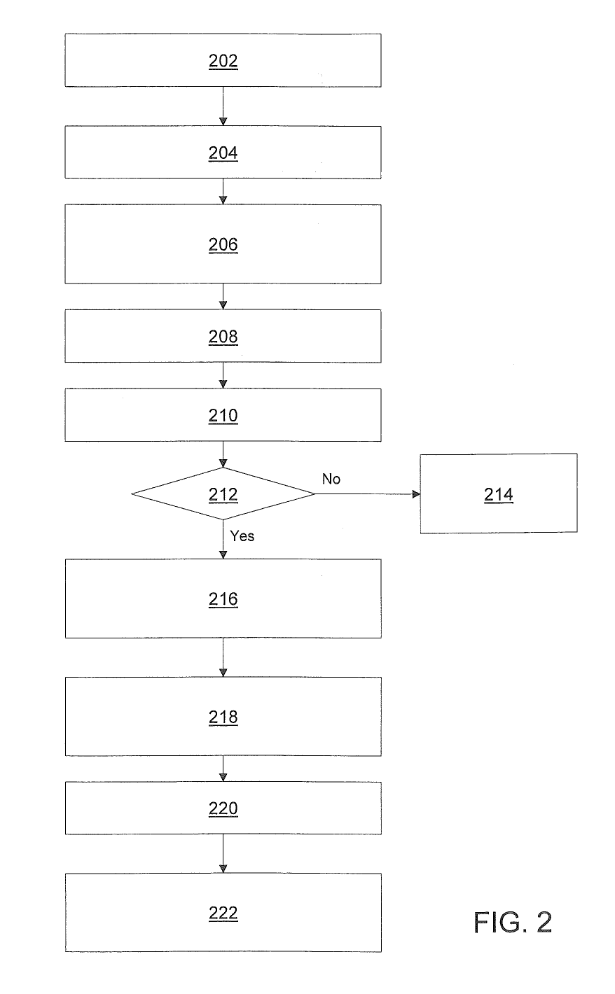

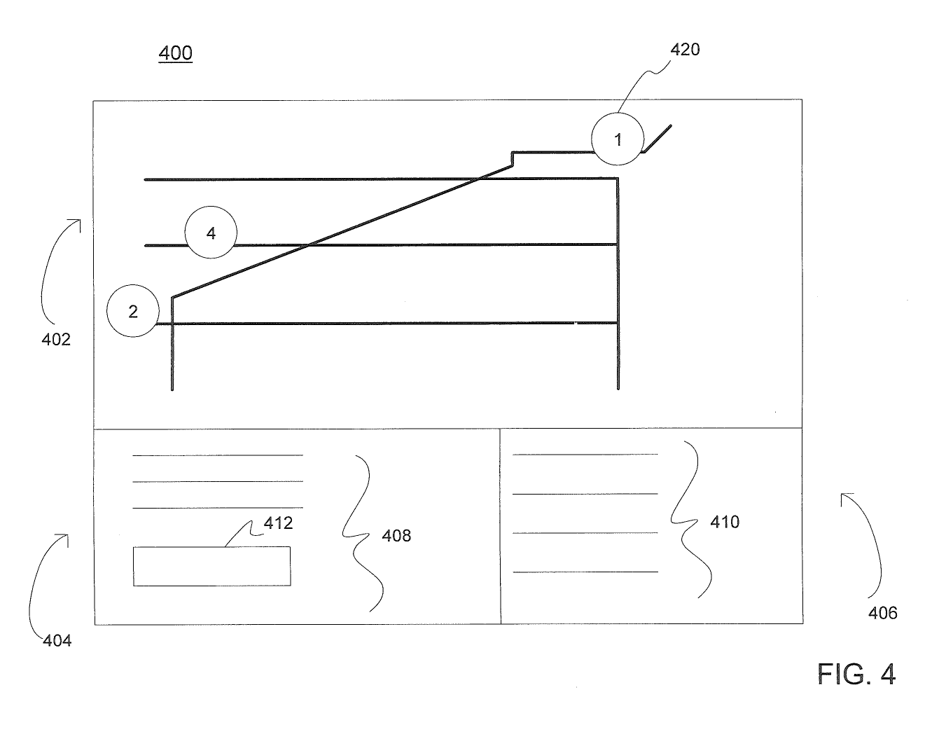

When a work crew in a vehicle requires a resource, e.g., either an inventory item, another vehicle, or even a work crew member, a member of the work crew accesses the communication system 104 of the vehicle, selects a resource from a listing via a user interface screen provided by the resource tracking services (e.g., via a display screen), and initiates a communication with a vehicle associated with the selected resource. A sample user interface screen 400 is shown in FIG. 4. Turning now to FIG. 2, a process for implementing the resource tracking will now be described in an exemplary embodiment. At step 202, the host system 102 receives vehicle information (e.g., vehicle identifier, vehicle type, and vehicle communication address) for each of the vehicles 101A-101n. At step 204, the host system 102 receives inventory information for each of the vehicles 101A-101n (e.g., an inventory item identifier, inventory item class, and/or description), which is encoded in a tag 132 disposed on the inventory item 130. The inventory item identifier may be any alphanumeric string that uniquely identifies the item. The inventory item class refers to a family of tools/equipment to which the item belongs. The description may be a name of the item.

At step 206, once this information (from steps 202 and 204) is received from the vehicles 101A-101n, the resource tracking logic 110 maps the vehicle information to the inventory information and builds a database including a record for each of the vehicles 101A-101n, whereby each record stores fields of information corresponding to a respective vehicle. The database table 300 may be stored in the storage device 112 of the host system 102 and/or the storage device 128 of the vehicles 101A-101n. As shown in FIG. 3, database table 300 illustrates five records corresponding to vehicle identifiers 1 through 5 in column 302. For each record, a field stores the vehicle type in a column 304. By way of non-limiting example, the vehicle type for vehicles 1 and 4 is a pickup truck, the vehicle type for vehicle 2 is a utility van, the vehicle type for vehicle 3 is a forklift, and the vehicle type for vehicle 5 is an excavator. In an exemplary embodiment, a vehicle having a particular vehicle type may be a resource that is requested and searched by a work crew, as will be described further herein.

Also, as shown in FIG. 3, a field stores a communication address for a respective vehicle in a column 306. A number of other fields are used to store inventory item identifiers that have been scanned for each vehicle, as shown in columns 308A-308n. For example, in the record for vehicle 1, inventory items for a generator, compressor, and a temperature gauge may be reflected in columns 308A, 308B and 308n. In the record for vehicle 2, inventory items for a compressor and a jack may be reflected in respective columns 308A and 308B. In the record for vehicle 4, inventory items for a jack, a generator, and a compressor may be reflected in the columns 308A, 308B, and 308n.

Once the database has been built, the database table 300 is searchable by the vehicles 101A-101n as will now be described. At step 208, a work crew member in a vehicle (e.g., a vehicle identified by vehicle ID 2 in database table 300) accesses the communication system 104 to request a resource. This may be implemented, e.g., via the user interface screen provided by the logic 124 (and/or the resource tracking logic 110). For example, as shown in FIG. 4, a user interface screen 400 includes three panels: a navigation panel 402, an inventory locator panel 404, and a vehicle locator panel 406. If the user wishes to search for an inventory item, the user may scroll through a list of equipment 408. For example, the listing may include gauges, generators 412, and hydraulics equipment.

As shown, e.g., in FIG. 4, the user has selected generators 412. The request may be transmitted over the networks 106 via the communication system 104 to the host system 102, and the resource tracking logic 110 searches the database table 300 in the storage device 112 at step 210. Alternatively, the request may be processed by the logic 124 and the processor 126 in the vehicle 101A, and the logic 124 searches the database table 300 in the storage device 128. At step 212, it is determined whether a resource exists in the database that matches the resource entered by the user (e.g., generators 412). If there is no match, this means that the requested resource is not located in any of the vehicles identified in the database table 300. In this scenario, the resource tracking may send a message to the requester at step 214 indicating that no resource is available, and directing the user to contact a main office or facility for assistance.

If, however, a match is found in the database table 300, the resource tracking logic 110 and/or logic 124 initiates a request for the location of the vehicle(s) having the resource at step 216. For example, as shown in FIG. 3, two vehicles (indicated as vehicles 1 and 4) have the generator requested by the vehicle identified as vehicle 2. The resource tracking logic 110 and/or logic 124 directs the identified vehicles to determine their location, e.g., via GPS components 126 of the corresponding vehicles. The locations are returned to the requesting vehicle (e.g., the vehicle identified as vehicle 2 in the database table 300), and the resource tracking logic 110 and/or 124 of the vehicle 2 populates the location information on the navigation panel 402 of the user interface screen 400 in the vehicle at step 218. Any icon may be used to identify the vehicles. As shown for illustrative purposes in FIG. 4, the icons reflect a number 420 corresponding to the vehicle identifier. As shown in FIG. 4, while two vehicles have the requested generator, the vehicle closest to the requesting vehicle 2 is vehicle 4. In one embodiment, the user may select one of the vehicles 1 and 4 at step 220 to initiate a communication requesting the resource at step 222. Alternatively, the resource tracking logic 110 and/or logic 124 may be configured to automatically initiate a communication with the vehicle 4 by retrieving the communication address in the corresponding column 406 associated with the vehicle 4, and executing the communication via the communication system 104.

If the selected vehicle is unable to spare the resource at the time requested by the vehicle 2, the vehicle 2 may initiate a second communication with other vehicles populated on the map, which are determined to have the resource (e.g., vehicle 1). Also, as indicated above, the resource requested may be a vehicle type. The user may select a vehicle type desired from a selection of vehicle types 410 provided in the panel 406. The resource tracking logic 110 and/or 124 process the request in a similar manner as that described above regarding the inventory item request.

Technical effects of the invention include providing a means for tracking the movement and location of work vehicles, as well as equipment loaded on the vehicles, and enabling the direct communication of this information among work crews in the field via communication components in the vehicles. The resource tracking eliminates the need for logistical control and management of vehicles from a central or head office, thereby allowing the work crew members or managers to redistribute resources or crew members faster and more efficiently than existing methods. The tracking of vehicle equipment may be implemented using RFID techniques, in which scanned data identifying the equipment resident in a vehicle is stored in memory at the vehicle. Inquiries about vehicle location can be initiated using GPS or similar methods, while inquiries about equipment location may be made over a communication system onboard the vehicle which queries the memory for the equipment information.

As described above, the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the present application.

What is claimed is:

1. A system for implementing resource tracking services, comprising:
a computer processor; and
logic executable by the computer processor, the logic configured to implement a method, the method comprising:
searching a database in response to a request for a resource, the request received from a first vehicle;
retrieving a record from the database that is identified with the resource, the record mapped to a second vehicle;
determining a geographic location of the second vehicle; and
populating a navigation system map at the first vehicle with an icon reflecting the geographic location of the second vehicle.

2. The system of claim 1, wherein the method further comprises:
automatically initiating a communication between the first vehicle and the second vehicle.

3. The system of claim 2, further comprising:
building the database, comprising:
receiving vehicle information for the first vehicle and the second vehicle, the vehicle information including a vehicle identifier and a communication address of each of the first vehicle and the second vehicle;
receiving inventory information for the first vehicle and the second vehicle; and
populating the database with the vehicle information and the inventory information;
wherein automatically initiating the communication is implemented by retrieving the communication address from the record and executing the communication using the communication address.

4. The system of claim 3, wherein the inventory information includes equipment loaded into and disposed within the first vehicle and the second vehicle.

5. The system of claim 4, wherein the resource includes at least one of the second vehicle and the equipment of the second vehicle.

6. The system of claim 4, wherein building the database further includes:
receiving a vehicle type associated with each of the first vehicle and the second vehicle, wherein the request for the resource comprises a request for a vehicle having the vehicle type.

7. The system of claim 3, wherein receiving inventory information for the first vehicle and the second vehicle includes receiving encoded data representing the inventory information via a scanning device, the encoded data affixed to corresponding inventory items.

8. A method for implementing resource tracking services, comprising:
searching a database in response to a request for a resource, the request received from a first vehicle;
retrieving a record from the database that is identified with the resource, the record mapped to a second vehicle;
determining a geographic location of the second vehicle; and
populating a navigation system map at the first vehicle with an icon reflecting the geographic location of the second vehicle.

9. The method of claim 8, further comprising:
automatically initiating a communication between the first vehicle and the second vehicle.

10. The method of claim 9, further comprising:
building the database, comprising:
receiving vehicle information for the first vehicle and the second vehicle, the vehicle information including a vehicle identifier and a communication address of each of the first vehicle and the second vehicle;
receiving inventory information for the first vehicle and the second vehicle; and
populating the database with the vehicle information and the inventory information;
wherein automatically initiating the communication is implemented by retrieving the communication address from the record and executing the communication using the communication address.

11. The method of claim 10, wherein the inventory information includes equipment loaded into and disposed within the first vehicle and the second vehicle.

12. The method of claim 11, wherein the resource includes at least one of the second vehicle and the equipment of the second vehicle.

13. The method of claim 11, wherein building the database further includes:
receiving a vehicle type associated with each of the first vehicle and the second vehicle, wherein the request for the resource comprises a request for a vehicle having the vehicle type.

14. The method of claim 10, wherein receiving inventory information for the first vehicle and the second vehicle includes receiving encoded data representing the inventory information via a scanning device, the encoded data affixed to corresponding inventory items.

15. A computer program product for implementing resource tracking services, the computer program product comprising a storage medium embodied with computer-readable program instructions, which when executed by a computer, cause the computer to implement a method, the method comprising:
searching a database in response to a request for a resource, the request received from a first vehicle;
retrieving a record from the database that is identified with the resource, the record mapped to a second vehicle;
determining a geographic location of the second vehicle; and
populating a navigation system map at the first vehicle with an icon reflecting the geographic location of the second vehicle.

16. The computer program product of claim 15, wherein the method further comprises:
automatically initiating a communication between the first vehicle and the second vehicle.

17. The computer program product of claim 16, further comprising:
building the database, comprising:
receiving vehicle information for the first vehicle and the second vehicle, the vehicle information including a vehicle identifier and a communication address of each of the first vehicle and the second vehicle;
receiving inventory information for the first vehicle and the second vehicle; and
populating the database with the vehicle information and the inventory information;
wherein automatically initiating the communication is implemented by retrieving the communication address from the record and executing the communication using the communication address.

18. The computer program product of claim 17, wherein the inventory information includes equipment loaded into and disposed within the first vehicle and the second vehicle.

19. The computer program product of claim 18, wherein the resource includes at least one of the second vehicle and the equipment of the second vehicle.

20. The computer program product of claim 18, wherein building the database further includes:
receiving a vehicle type associated with each of the first vehicle and the second vehicle, wherein the request for the resource comprises a request for a vehicle having the vehicle type.
